(19) United States
(12) Patent Application Publication
(10) Pub. No.: US 2007/0030618 A1
(43) Pub. Date: Feb. 8, 2007

(54) Method and device for producing and/or adjusting and electromagnetically controllable actuator

(76) Inventors: Micha Heinz, Darmstadt (DE); Wolfgang Joeckel, Obertshausen (DE); Claude Steinbach, Frankfurt/M (DE); Axel Schmitz, Hattersheim (DE); Andreas Richter, Neu-Anspach (DE); Philipp Dordelmann, Bad Homburg (DE); Andreas Ketel, Wiesbaden (DE); Winfried Simon, Echzell (DE); Mario Engelmann, Steinbach/Ts (DE); Wolfgang Fey, Niedernhausen (DE)

Correspondence Address: CONTINENTAL TEVES, INC., ONE CONTINENTAL DRIVE, AUBURN HILLLS, MI, 48326-1581, US

(21) Appl. No.: 10/566,422

(22) PCT Filed: Jul. 28, 2004
(86) PCT No.: PCT/EP04/51635

§ 371 Date: Jul. 3, 2006

(30) Foreign Application Priority Data
Jul. 31, 2003 (DE) 103 35 586.3
Nov. 25, 2003 (DE) 103 55 388.6
Nov. 26, 2003 (DE) 103 55 836.5

(51) Int. Cl. H01H 47/00

(52) U.S. Cl. 361/160

(57) ABSTRACT

In a method for producing and/or adjusting an electromagnetically controllable actuator which is appropriate to control the flow of a fluid, at least one electromagnetic property of the actuator is measured, and the measured electromagnetic property itself or a quantity derived therefrom is used as an actual value for a control of a correcting variable. This correcting variable is taken into account directly to produce or adjust the actuator. A suitable device for this calibration comprises a control circuit and a mounting location, where the actuator can be mounted into the device, and is designed to adjust at least one mechanical property of the actuator by way of the correcting variable.

### BACKGROUND OF THE INVENTION

The present invention relates to a method for producing and/or adjusting an electromagnetically controllable actuator which is appropriate to control the flow of a fluid, in particular a hydraulic or pneumatic analog valve or an analogized on-off valve, with the actuator comprising an electromagnetic arrangement that can be driven by means of an exciter coil including at least one movable armature, and with the electromagnetic arrangement acting mechanically on a valve actuating device for opening and closing the actuator, with the valve actuating device comprising at least one closing element, a resetting element for opening or closing the closing element when the exciter coil is not excited, and a valve seat into which the closing element for opening or closing the actuator engages as well as to an adjustment device for producing and/or mechanically adjusting an electromagnetically controllable actuator, in particular a pneumatic or hydraulic valve, comprising an electromagnetic exciter coil which is a component part of the adjustment device and an accommodation which allows inserting an actuator that is electromagnetically drivable by the exciter coil, said actuator comprising at least one armature, a movable tappet, and a valve actuating device, wherein the armature can be moved by the exciter coil current to open and/or close the actuator.

It is known in prior art to employ electromagnetically operable analogized valves for an improved control or for noise reduction in ABS control units for motor vehicle brake systems but also in so-called driving dynamics controllers equipped with additional functions such as ESP, etc.

So-called analogized pilot valves are used in up-to-date generations of hydraulic control units. An analogized pilot valve is a current-driven solenoid valve which is per se designed for complete opening or closing, however, is so operated by specific current adjustment that it has analog control properties.

EP 0 813 481 B1 discloses a method for the detection of the switch point of a pilot valve of analog operation, in particular for determining the pressure conditions from the current variation of the valve actuating current.

In principle, it is consequently possible to adjust the pressure gradient or flow G of a corresponding analogized pilot valve in dependence on the differential pressure by way of variation of the current through the magnet coil of the valve. The volume flow Q in the range of the control must be adjusted with a very high rate of precision. The essential coefficients of influence are the differential pressure Δp, the current I through the magnet coil of the valve and various valve parameters. Although it is possible to use characteristic fields in order to define the desired flow, it is not easily possible to store the dependency of the above quantities in a once defined characteristic field. This results from the fact that tolerances of the valve components being due to manufacture have a relatively great influence on the needed drive current. It is therefore necessary to determine a characteristic field for each individual valve during manufacture of the valves and to store it in a memory of the electronics of the control unit. To establish the individual characteristic fields, however, a complicated measuring method is necessary with defined pressurizations of the control units at the supplier's site or at the end of the assembly line at the plant of the motor vehicle manufacturer. The characteristic fields determined by way of the sophisticated measuring method may then be used to adjust the desired pressure gradient, as has been described e.g. in WO 01/98124 A1.

It has been found that the causes for the remaining deviations of the characteristic curves, or their gradients in particular, predominantly originate from the tolerances of mechanics, e.g. the changing spring force and the magnetic field circuit (e.g. magnetic resistances of the air slots, etc.). Therefore, there is the need for valves which, in series production, exhibit a deviation as insignificant as possible in electromagnetic and mechanical properties.

### SUMMARY OF THE INVENTION

According to the invention, this object is achieved by a method of the above-mentioned kind in which at least one electromagnetic property of the actuator is measured and the measured electromagnetic property itself or a quantity derived therefrom is used as an actual value for a control of a correcting variable, and this correcting variable is taken into account directly to produce or adjust the actuator and by an adjustment device with a control circuit, wherein the actual value is an electromagnetic property of the actuator that can be mounted into the adjustment device, and at least one mechanical property of the actuator is adjusted by way of the correcting variable.

According to the method of the invention, at least one electromagnetic property of the actuator is measured, and the measured electromagnetic property itself or a quantity derived therefrom is used as an actual value for controlling a correcting variable. This correcting variable is furthermore taken into account directly for the manufacture or adjustment of the actuator.

The terms ‘controlling’ and ‘control’ relate to an operation wherein a variable, i.e. the variable to be controlled (controlled variable, actual value) is continuously sensed, compared with another variable, the command variable (nominal value), and influenced in the sense of adapting the command variable. What is characteristic of controlling is the closed action sequence, wherein the controlled variable in the line of action of the control circuit is continuously influencing itself.

The control is preferably performed by means of a programmed electronic controller. The correcting variable expediently is at least one mechanical property of the actuator, and it is especially the tappet stroke 1 defined hereinbelow and/or an air slot in the magnetic arrangement.

The term ‘actuators’ relates to valves and slides for the adjustment of fluid flow. Preferably, the actuator used is a valve. The fluid preferred is air or also any appropriate hydraulic fluid which is in particular a customary brake fluid in the application with a brake. The actuator comprises an electromechanical arrangement and a valve actuating device with a closing element. The electromechanical arrangement favorably comprises a closing element which is mechanically connected to an armature. Advantageously, the closing element is a tappet. The closing element is moved back by a resetting element in the absence of current through the exciter coil. The resetting element is preferably a resetting spring which acts on the resetting element.

It is preferred that the derived quantity is the magnetic force.

The quantity derived from the electromagnetic property is preferably the magnetic force F_{mag} acting on the closing element. This force is considered in particular in relation to the force of the resetting element F_{spring}.

In a furthermore preferred manner, the derived quantity concerns the opening travel 1 which will be defined hereinbelow and/or the hereinbelow defined spring force F_{spring} of the actuator.

Favorably, the actuator has a completely opened and a completely closed position. Depending on the type of actuator, normally open (NO-V) or normally closed (NC-V), the actuator adopts one of these positions, in response to the action of a resetting element. An appropriate resetting element is preferred to be a spring which has a defined force/travel characteristic curve that can be approximated especially by a linear equation.

The method of the invention is advantageously implemented for manufacturing valves for an electrohydraulic device for the brake control of motor vehicles, such as an ABS/ESP brake control unit.

As has been mentioned hereinabove, it has been found that the causes for the undesirable deviations of the actuator characteristic curves, or their gradients in particular, predominantly originate from the tolerances of mechanics, e.g. the changing spring force Fspring and the magnetic field circuit (e.g. magnetic resistances of the air slots, etc.) of the actuator.

The measured electromechanical property favorably is one or more properties of the actuator from the group:

magnetic resistance R_{M} of the electromechanical arrangement,

inductance L of the electromechanical arrangement,

the electrically measured magnetic force F_{magn} acting on the valve actuating device,

the holding current I_{hold} necessary for opening or closing, or

the opening current Iₒₚₑₙ necessary for opening or closing.

According to the method of the invention, preferably, the opening current, the holding current, the magnetic resistance, or the inductance is adjusted by the controller. This can be done, for example, when the actuator is completely closed or also in conditions of the actuator being actuated in a defined manner. In particular in the case of a valve, the air slot, for example the residual air slot, in the magnetic arrangement between armature and tappet guide is reduced by displacing the valve seat to an extent until the total magnetic resistance corresponds to a desired value.

To perform the control according to the invention, it is preferred to continuously change the nominal value of the exciting current in the exciter coil according to a predetermined pattern, e.g. a saw-tooth pattern or a ramp. In this case, the point of time of the valve holding current is determined from the temporal actual value of the exciting current and/or the induced voltage. The induced voltage at the exciter coil and/or at a measuring coil in the magnetic circuit is measured to define the controlled variable. Instead of the valve holding current, it is also possible to determine the valve opening current which indicates the point of opening of the valve. If, for example, the nominal value of the exciting current is reduced continuously in the form of a ramp, an irregularity in the electrical behavior of the exciter coil will show at the point of time of the valve opening when the armature is moving, under the condition that the current source used is not ideal. This irregularity can be identified when monitoring the exciting current, the voltage at the exciter coil or, especially emphasized, the induction voltage of a measuring coil which is additionally fitted in the magnetic circuit. The valve holding current can be defined by determining the point of time of this irregularity.

Instead of the ramp-like decrease of the exciting current (or increase), it is also possible to change the exciting voltage in a ramp-like fashion or according to a predetermined pattern in an alternatively preferred embodiment.

To measure the electromagnetic property, at least one additional inductive component is arranged advantageously in the magnetic circuit of the actuator beside the exciter coil, the induction voltage of which component is taken into account for calculating the electromagnetic variable. The additional inductive component is a measuring coil in particular.

The electromagnetic property is in particular the integrated voltage at the measuring coil in the case of a measuring coil employed.

From the induced voltage measured this way or in any other way and the subsequently produced integral value, the magnetic flux is preferably determined according to the method, and therefrom the magnetic force and/or the tappet stroke are determined.

According to a preferred embodiment of the method, the holding current and/or opening current of the actuator are determined from the actuator-related parameters.

An object of the invention involves achieving during a production process a minimum possible deviation or a uniform behavior in the electric characteristic curves with respect to the pressure quantity to be adjusted. Preferably, this is a characteristic curve which defines the interrelationship between opening current and differential pressure. Therefore, the actuator is exposed to an accurately defined predetermined differential pressure and/or an accurately defined predetermined flow during the manufacture or adjustment according to another preferred embodiment of the method.

When an additional increase in precision of brake control is desired, in particular for compensating long-time wear effects, it may be suitable according to another preferred embodiment of the invention, to carry out in the beginning an additional adjustment of the actuator outside an object, which is e.g. a motor vehicle, and to subsequently, after the installation of the actuator into the object, perform an adjustment inside the object in which the valve is used, said adjustment being likewise based on the measurement of electromechanical properties.

After the manufacture and/or adjustment, another calibration is performed according to this favorable embodiment of the method without using pressurizations of the actuator, which is in particular characterized in that this calibration is independently carried out by the electronic control of the brake system. As stated before, this allows further improving the accuracy in an analog control of the actuator by means of the actuator manufactured according to the invention. According to this method, wherein actuator-related parameters are determined automatically without using pressurizations (differential pressure ΔP=0) of the actuator, it is especially preferred to control the tappet force or the magnetic resistance by considering the integrated electric induction voltage at the coil of the actuator as a controlled variable.

To comprehend the invention, it may be expedient to classify the characteristic features of an actuator for the simplification of the technical interrelationships into individual magnetic and mechanical properties, which can be described e.g. by parameters KG_{ind}, and general magnetic and mechanical properties, which can be described e.g. by parameters KG_{gen}. The parameters KG_{ind} comprise quantities with especially wide deviations, due to tolerances depending on the respective valves. The parameters KG_{gen} relate to parameters which are less subjected to deviations and can be fixed once for the type of construction or the line of products. Therefore, the general parameters KG_{gen} can suitably be stored durably in an electronic control unit inside the object. The actuator characteristic curve and, thus, the necessary drive current, being responsive to the differential pressure, for the respective actuator can then be easily calculated. It is, of course, possible to memorize characteristic fields, calibration curves, or the like, in lieu of the characteristic quantities.

According to a favorable embodiment of the method, the total magnetic resistance Rₘ of the magnetic circuit is measured in the electromagnetic arrangement. It applies in general that instead of the magnetic resistance, it is also possible to use the inductance L of the corresponding magnetic circuit, related to the number of windings N of the coil, as an equivalent physical quantity in a corresponding manner for implementing the method of the invention.

At least one additional measuring element, in particular at least one measuring coil is preferably provided in the magnetic circuit, said measuring coil being used to measure the inductance, the magnetic flux, or the magnetic resistance, respectively. Apart from a coil, it is principally feasible to use as a measuring element further, per se known magnetic-field-responsive sensors, such as Hall sensors, MR sensors, etc., provided they are appropriate to sense the effective magnetic flux. The use of a coil appears, however, especially expedient due to the possibility of its low-cost manufacture.

The measuring coil described hereinabove can be electrically independent of the drive coil. It is, however, feasible according to a preferred embodiment to connect the measuring coil electrically in series with the drive coil. This is advantageous because only three actuating lines are required.

The flow G through the actuator or valve, respectively, apart from the differential pressure and the geometric flow properties, is principally defined by the force which acts on the tappet of the respective actuator (tappet force). The magnetic force F_{magn}, the pressure-responsive force F_{hydr} (e.g. pneumatic or hydraulic) caused by the fluid, and the force F_{spring} exerted by the resetting element act simultaneously on the tappet of the valve. These jointly acting forces will compensate each other in the equilibrium of forces (tappet stands still). In this condition, it is just the so-called holding current I_{hold} which flows in the case of a magnetic force produced by way of an exciter coil.

According to the method of the invention, the spring force, and if necessary the maximum tappet stroke is preferably determined in a calculation routine. These quantities will then be included in the calculation of force, for example.

A special feature of the method of the invention among others resides in that preferably the magnetic flux is measured, and the control is carried out according thereto in particular. This is suitable because the magnetic force directly depends on the magnetic flux.

The invention also relates to an adjustment device for the manufacture and/or mechanical adjustment of an electromagnetically drivable actuator, favorably allowing the implementation of the above method. The device itself comprises an electromagnetic exciter coil, and the actuator (which normally does not have an exciter coil in this case) can be slipped into a corresponding accommodation in the coil. The adjustment device is characterized by a control circuit which, as an actual value, uses an electromagnetic property of the actuator that can be inserted into the adjustment device. The correcting variable of the control acts by way of the adjustment device on a mechanical property of the actuator so that this mechanical property, which is the tappet stroke, for example, can be adjusted by means of the device.

It is preferred that the adjustment device comprises an additional inductive component which furnishes an electric signal to form the actual value of the control circuit, the inductive component being a measuring coil, in particular.

Favorably, the correcting variable of the control changes the distance of the fixing device for the pressed material of a press arrangement which can receive the actuator for the purpose of a press-in operation. To this end, in particular the distance of the press holder arms is controlled by the controller. The distance is controlled in particular by presetting a speed signal (closing speed of the holder) or a distance signal. It is, however, also possible that the controller adjusts the pressing power.

In the adjustment method described hereinabove, the valve seat of a valve is favorably adjusted by means of a press-in operation. The insertion dimension is preferably in a range of 0.2 μm to 500 μm approximately.

Further preferred embodiments can be seen in the subsequent description of embodiments by way of Figures.

### BRIEF DESCRIPTION OF THE DRAWINGS

In the drawings:

FIG. 1 is a schematic view of the valve calibration process;

FIG. 2 is the design of a valve that can be employed according to the invention;

FIG. 3 is a schematic view of an adjustment device for adjusting a valve, and;

FIG. 4 shows a schematic view for explaining the adjustment control circuit.

### DETAILED DESCRIPTION OF THE DRAWINGS

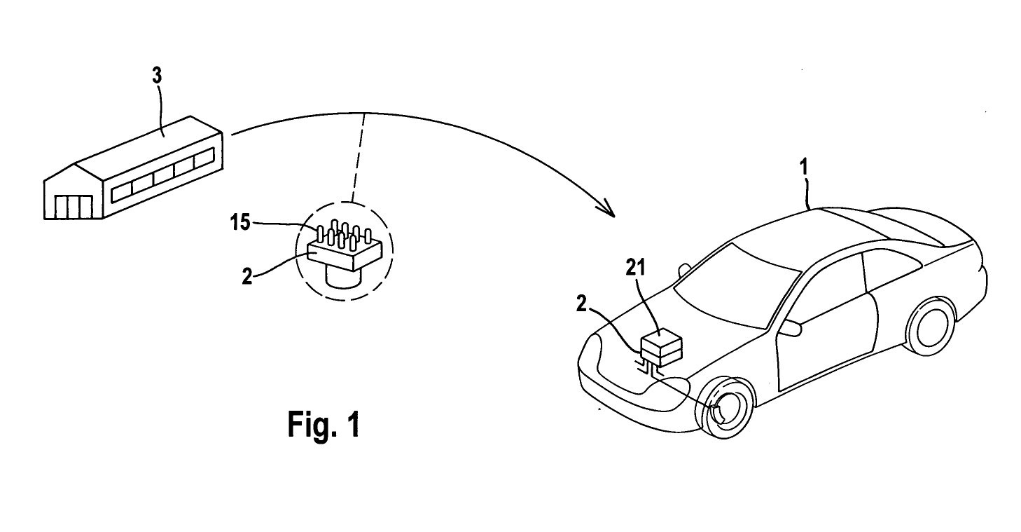

FIG. 1 explains the manufacturing process of a solenoid valve 15 for an electrohydraulic brake system 2 in a motor vehicle 1 with an ABS/ESP function. Initially, the solenoid valves are mechanically adjusted at manufacturing plant 3 after their manufacture according to the method of the invention in terms of a uniform opening current behavior, and they are then mounted into brake control unit 2. Due to residual tolerances, either existing or appearing in the course of time, it is possible, if a particularly high rate of precision in brake control is desired, to additionally carry out the subsequently described calibration process in the motor vehicle by way of the electronic controller 21, after the brake control unit 2 has been mounted into motor vehicle 1.

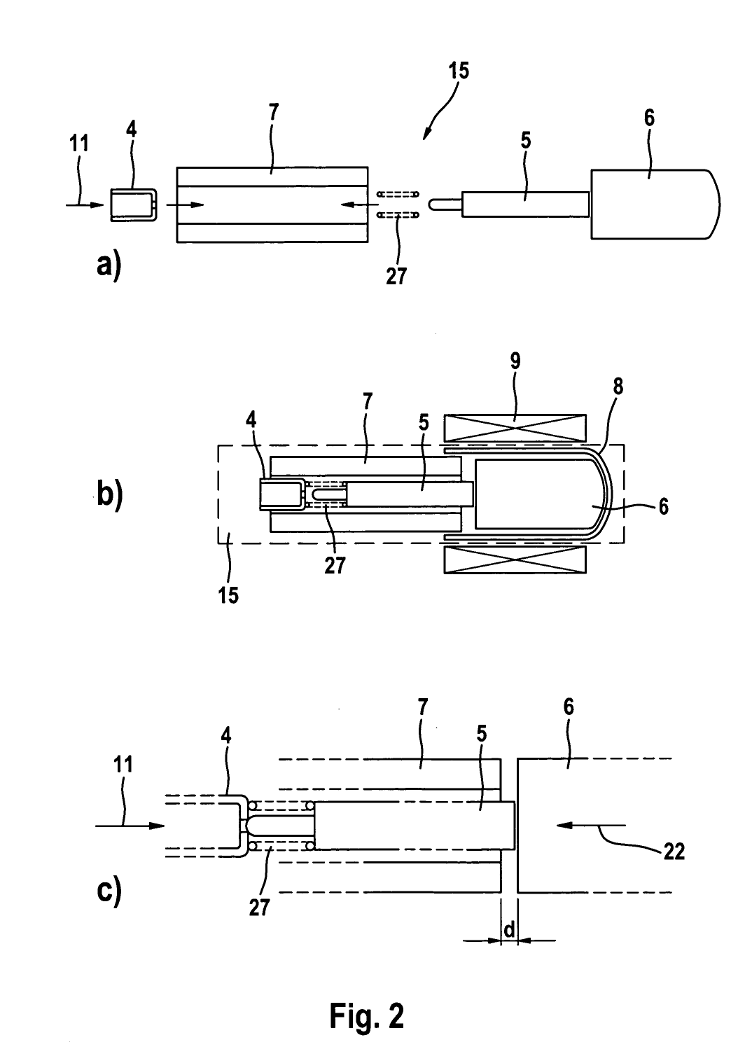

FIG. 2 shows a greatly schematic view of the design of a typical solenoid valve 15. Armature 6, housing 7, sleeve 8, and coil 9 are component parts of the electromagnetic arrangement which acts mechanically on the actual valve. To be more specific, the armature 6 is moved by the magnetic field of valve coil 9, thus acting mechanically on tappet 5. In the example of a normally open valve (NO valve), resetting spring 27 urges tappet 5 to adopt the open position when there is no magnetic field. Partial image c) shows the valve in the closed position, with the valve coil energized. Tappet 5 closes the opening in the valve seat 4 then. In the closing operation of the valve, armature 6 of the illustrated valve will approach housing 7, yet does not fully touch it. The remaining space between armature and housing is referred to as residual air slot d. According to the method described herein, the residual air slot d is adjusted by a displacement of valve seat 4 in the direction of arrow 11. This is done by considering the magnetic resistance in the closed valve position or by considering the opening current which can be found out from the defined excitation of the exciter coil 9 as will be described hereinbelow.

A second adjustment is performed in the open position of the valve. Armature 6 abuts on sleeve 8 when the valve is fully opened. The distance between completely closed position and completely opened position is referred to as tappet stroke and can be determined by a comparing consideration of the magnetic resistance in the opened position and in the closed position. The tappet stroke can be adjusted by displacement of sleeve 8.

Calibration Process in the Motor Vehicle

The above-mentioned calibration process in motor vehicle 1 is executed automatically in the electronic control unit 21 of the brake control unit and is used to calculate the opening current characteristic curves in each individual valve required for the valve flow control. One special feature of this calibration operation is that the actual calibration operation is carried out without pressurization of the valves. Therefore, the calibration operation is at any time self-supporting and can be executed independently of a workshop visit. The spring force is determined individually in this example. To begin with, the coil current I of the normally open solenoid valve 15 is gradually increased (in each case when enabling and disabling the valve current). Starting with a defined current the valve will close, armature 6 moves in the direction of the arrow 22 (FIG. 2c). The movement of the armature causes a reduction of the air slot between armature 6 and housing 7 and, hence, a measurable change of the total magnetic resistance Rm and, thus, also the inductance L

$$L = \frac{{N}^{2}}{{R}_{m}} , \\ Φ = \frac{N \times I}{{R}_{m}}$$

will apply then (N=number of windings of the coil, Φ=magnetic flux).

At the time of commencement of the movement of armature 6, there is a condition of equilibrium between the magnetic force F_{magn} and the spring force F_{spring} acting on the armature, with the differential pressure ΔP=0:

$${F}_{spring} = {F}_{magn} = \frac{1}{2 * {μ}_{0} * {A}_{armature}} * {Φ}^{2} ,$$

(μ₀=permeability constant of the air, Aₐᵣₘₐₜᵤᵣₑ=armature surface). Thus, the spring force F_{spring} can be calculated from the magnetic flux Φ in consideration of the armature surface Aₐᵣₘₐₜᵤᵣₑ. The tolerance-induced deviations of the spring forces which are measured this way can then be stored in a memory of controller 21.

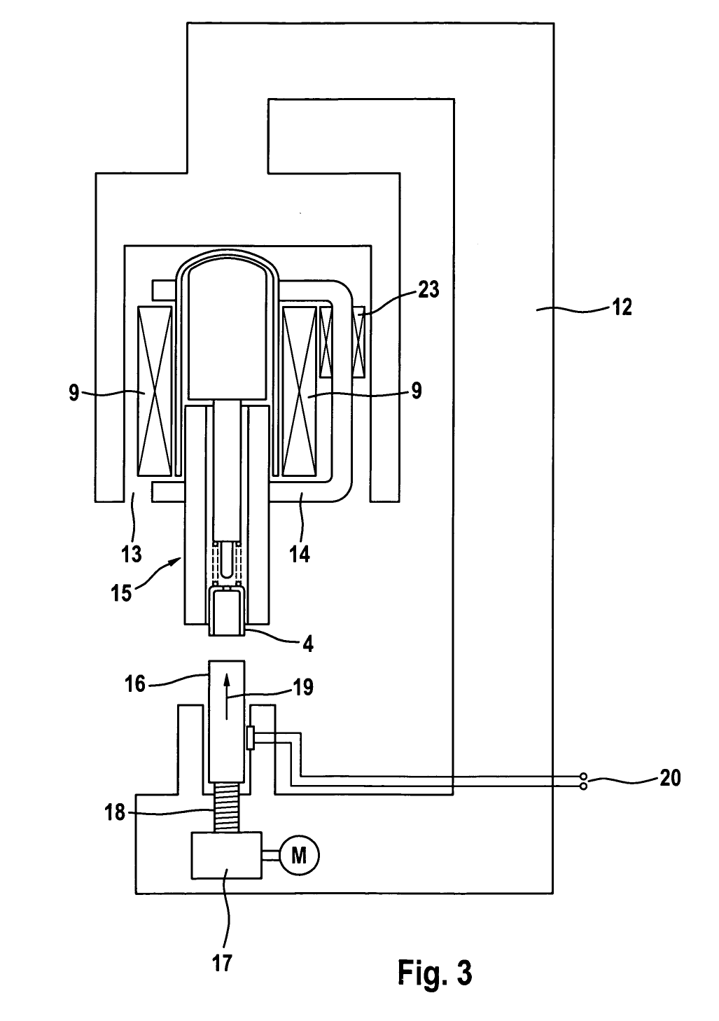

The schematic representation in FIG. 3 shows a press 12 used to adjust the valve seat 4 of the valve 15. Press 12 comprises in its upper part a press accommodation 13 into which the valve 15 can be inserted. Integrated in valve accommodation 13 is exciter coil 9 for actuating the valve 15. Further, valve accommodation 13 comprises an outside iron core 14 onto which additional windings of a measuring coil 23 are wound. The flux in the magnetic circuit can be determined by means of measuring coil 23 in a particularly simple fashion.

Press tappet 16 is guided axially in the bottom part of the press so as to be displaceable in the direction of the arrow 19. The position of press tappet 16 can be adjusted by way of drive 17 using spindle 18. The absolute position of tappet 16 can be predetermined by an electric signal by way of electric input 20. To impress the valve seat 4 in housing 7, the press tappet is moved continuously in the direction of the arrow 19 at speed

$$v = \frac{Δ X}{Δ t} .$$

Exciter coil 9 is energized with a current according to a predetermined pattern (e.g. saw-tooth pattern, etc.), and the current has adopted a value which is changed in such a fashion, depending on whether the valve is initially opened or initially closed, that the valve is operated. The pattern is favorably designed in such a way that the valve is operated repeatedly in regular intervals (clockwise actuation).

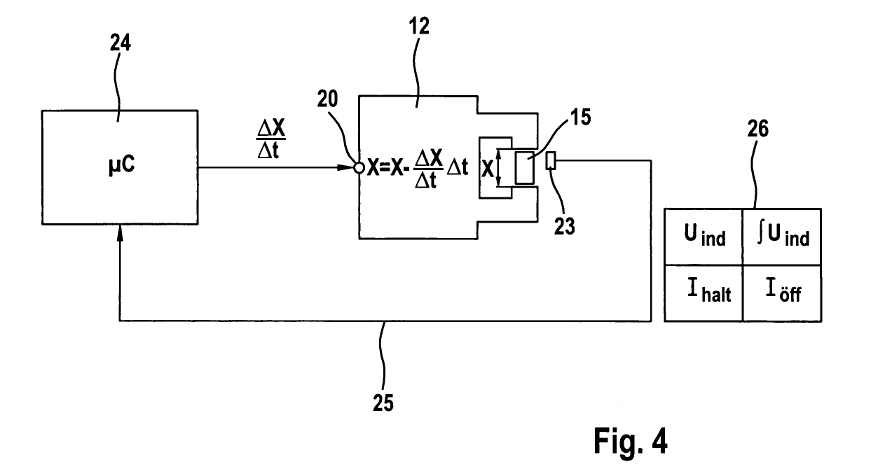

The closed control circuit for the adjustment of the electromagnetic property is represented in FIG. 4. Press control electronics 24 produces a correcting variable ΔX/Δt predefining the press-in speed for press 12 and being sent to the input 20. Valve 15 is compressed in response to this signal. By feedback of an electromagnetic quantity 26 of the valve through line 25, a control loop develops in conjunction with the press which allows controlling the desired electromagnetic quantity of the valve in a particularly accurate manner by press electronics 24. As is illustrated in the box in FIG. 4, the electromagnetic quantity 26 fed back can be either the induced voltage U_{ind} measured at exciter coil 9 or at separate measuring coil 23, or an electronically determined integral value ∫U_{ind} of this quantity.

The integral value ∫U_{ind} is proportional to the magnetic flux so that a flux control is realized herein. In case that the induced voltage is transmitted through line 25, it is required that the integral is produced in the electronics 24 prior to the actual control operation. Alternatively, the present valve holding current I_{hold} or the valve opening current Iₒₚₑₙ can be transmitted as a controlled variable through line 25 to electronics 24.

An example for defining the valve tappet stroke 1 is subsequently described. The physical interrelationships explained hereinbelow are made the basis for the following calculation of the tappet stroke:

$${U}_{ind} = - N * \frac{ⅆ Φ}{ⅆ t}$$

$$and$$

$$Φ = - \frac{1}{N} {\int }_{0}^{t} {U}_{ind} ⅆ t .$$

When the valve current I is disabled, there will be a change of the magnetic flux Φ in valve 15 which causes an induction voltage U_{ind} at exciter coil 9 or measuring coil 23. The total magnetic resistance R_{M} can be measured in the open and closed condition of the valve. It is composed of the magnetic resistance of the air slot at the armature

$${R}_{M}^{air} = \frac{l}{{μ}_{0} * {A}_{armature}} ,$$

which depends on the position of the armature, where Aₐᵣₘₐₜᵤᵣₑ is the magnetically effective surface of the armature 6 which is specific for the line of products of the valve, and reference numeral 1 designates the tappet stroke. The actual method of measurement does not establish the value for R_{M}^{air} directly, but uses a measurement of the magnetic resistance when the valve is completely opened and a subtraction of the magnetic resistance of the closed valve. Consequently, the tappet stroke 1 may be defined this way alone from a measurement of the electromagnetic properties.

In the example described hereinabove, the valve is always completely closed or completely opened during the measurement of the magnetic resistance. An example for an adjustment method with clock-controlled valve opening will be described in the following. Initially, valve seat 4 is shifted into housing 7 for adjusting the air slot d when the valve is closed so that the magnetic resistance of the closed valve will continuously increase. The current in the exciter coil is at first higher than the closing current of the valve. When the press is compressed at constant speed, the valve will be opened at repeated times, that means clockwise, by way of the current in the exciter coil 9, and the valve opening current is determined as this occurs. It is possible to determine the valve opening current by considering the time variation of the induction voltage and/or the exciter coil voltage and/or the coil current because a measurable peak in the voltage and current variation of the coils arranged in the magnetic flux circuit results during the movement of the valve armature 6 that occurs in this case. The valve opening current of the valve can be determined in a defined present air slot adjustment from the range of the current that flows at the time of the peak. The determined opening current is transmitted to control unit 24 in punctual manner. The punctual or clocked determination takes place with a measuring frequency which is so high that a quasi-continuous control signal is available for the adjustment of the press.

The above explanations relate to a valve which is normally open (NO valve). The described method can be employed in a similar way also for valves which are normally closed (NC valves).

1-14. (canceled)

15. A method for adjusting an electromagnetically controllable actuator designed to control the flow of a fluid, the actuator comprising an electromagnetic arrangement that can be driven by means of an exciter coil (9) including at least one movable armature (6), and with the electromagnetic arrangement acting mechanically on a valve actuating device for opening and closing the actuator, the valve actuating device comprising at least one closing element (5), a resetting element (27) for opening or closing the closing element when the exciter coil is not excited, and a valve seat (4) into which the closing element for opening or closing the actuator engages, the method comprising the steps of
measuring at least one electromagnetic property of the actuator,
selecting a measured quantity correlating with the electromagnetic property as an actual value for controlling a correcting variable, and
adjusting the electromagnetic property by directly taking this correcting variable into account.

16. The method as claimed in claim 15,
wherein the electromagnetic property is at least one of the properties out of the group consisting of the magnetic resistance R_{M} of the electromechanical arrangement, the inductance L of the electromechanical arrangement, the electrically measured magnetic force F_{magn} acting on the valve actuating device, the holding current l_{hold} necessary for opening or closing, and the opening current lₒₚₑₙ of the actuator necessary for opening or closing.

17. The method as claimed in claim 15,
wherein the electromagnetic property is adjusted by the controller when the actuator is completely closed.

18. The method as claimed in claim 15,
wherein the electromagnetic property, is adjusted by mechanical adjustment of the armature stroke when the actuator is completely opened, and/or an air slot in the magnetic arrangement when the actuator is completely opened.

19. The method as claimed in claim 15,
wherein the electromagnetic property is adjusted by mechanical adjustment of an air slot in the magnetic arrangement when the actuator is completely opened.

20. The method as claimed in claim 15, including the step of
applying a current variation at a coil in the electromagnetic arrangement, wherein an induced voltage is the electromagnetic property.

21. The method as claimed in claim 20,
wherein the coil is the exciter coil, wherein the current variation incudes continuously changing a nominal value of the exciting current according to a predetermined pattern and determined from at least one of the following values:
a temporal actual value of the exciting current, the induced voltage of the valve opening current, and the induced voltage of the valve holding current; and
wherein the induced voltage is measured at at least one of the two following coils: the exciter coil and a measuring coil in the electromagnetic arrangement.

22. The method as claimed in claim 21,
wherein the current pattern corresponds to a saw-tooth-shaped course.

23. The method as claimed in claim 15,
wherein the adjustment is a mechanical adjustment being performed during the manufacturing process of the valve.

24. The method as claimed in claim 15,
wherein initially the adjustment is performed outside an object (1,2) and, after the installation of the actuator into the object, an adjustment is performed inside the object in which the actuator is used, said adjustment being likewise based on the measurement of electromechanical properties.

25. The method as claimed in claim 24,
wherein the adjustment outside the object is focused on compensating the influence of tolerances on the opening current characteristics, which are especially based on a different force/travel variation of the resetting elements.

26. An adjustment device for mechanically adjusting an electromagnetically controllable actuator, comprising an electromagnetic exciter coil (6) which is a component part of the adjustment device and an accommodation which allows inserting an actuator that is electromagnetically drivable by the exciter coil,
wherein the adjustment device comprises a control circuit with an input quantity being an electromagnetic property of the actuator that can be mounted into the adjustment device, wherein the control circuit determines a correcting variable which serves to adjust at least one mechanical property of the actuator.

27. The adjustment device as claimed in claim 12,
wherein the correcting variable determines the position (X,ΔX) of a holding device of a press arrangement.
